(19) United States
(12) Patent Application Publication
(10) Pub. No.: US 2002/0137473 A1
(43) Pub. Date: Sep. 26, 2002

(54) Radiation shield for cellular telephones

(76) Inventor: Deborah L. Jenkins, Dallas, TX (US)

Correspondence Address: OLTMAN, FLYNN & KUBLER, 915 MIDDLE RIVER DRIVE, SUITE 415, FORT LAUDERDALE, FL, 33304, US

(21) Appl. No.: 09/803,041

(22) Filed: Mar. 12, 2001

(51) Int. Cl. H04B 1/38

(52) U.S. Cl. 455/90; 455/575; 455/550

(57) ABSTRACT

A shield apparatus for placement over speaker openings of a cellular or cordless telephone to obstruct passage of harmful electromagnetic signal radiation from the telephone to the user ear includes a first glue ring for bonding the apparatus over the speaker openings of a telephone; a first mesh layer adhesively engaged by the first glue ring for absorbing signal radiation while permitting passage of sound waves; a second glue ring adhesively engaging the first mesh layer; and a second mesh layer engaged by the second glue ring for absorbing residual signal radiation penetrating the first mesh layer. The apparatus preferably still additionally includes a metal frame ring bonded to the second mesh layer and extending along the periphery of the second mesh layer for absorbing radiation directed laterally toward the user ear.

### BACKGROUND OF THE INVENTION

1. Field of the Invention

The present invention relates generally to the field of telephone accessories. More specifically the present invention relates to an improved shield apparatus for placement over the speaker openings in a cellular or cordless telephone to obstruct passage of harmful electromagnetic signal radiation from the telephone to the ear. The shield apparatus incorporates several layers of various materials which, in order from telephone mounting surface outward, include a first glue ring for bonding the apparatus over the speaker openings of a telephone, a first mesh layer adhesively engaged by the first glue ring for absorbing signal radiation while permitting passage of sound waves, a second glue ring adhesively engaging the first mesh layer and a second mesh layer engaged by the second glue ring for absorbing residual signal radiation passing through the first mesh layer. To absorb radiation directed toward the ear from the periphery of the apparatus and to enhance the appearance of the apparatus, the apparatus preferably additionally includes a resilient metal frame ring bonded with a suitable adhesive to the outward face of the second mesh layer so that the frame ring extends along the entire second mesh layer periphery. A company name or other identifying information is preferably printed on the frame ring, such as by silk screening. A bead of solidified gelatin is preferably provided over the exposed face of the frame ring. The apparatus may have any of numerous peripheral shapes, but is preferably elliptical, with all layers having a correspondingly dimensioned elliptical shape.

2. Description of the Prior Art

In recent years the medical profession has become increasingly concerned about the harmful effects that high frequency electromagnetic signal radiation from cellular telephones and even from household cordless/portable telephones can have on the human body, and specifically on the cranial tissues. Signals from cellular telephones are amplified beyond those of ordinary cordless telephones because they must reach a distant receiving tower. The human skull largely shields the tissues of the brain and inner ear from these signals, but the skull has openings at the ears where the signal radiation can enter without obstruction and cause harm. People who often use cellular telephones have been known to develop serious ailments such as memory loss, hearing loss and brain tumors, and there is mounting evidence that these ailments are the direct result of cellular telephone radiation exposure.

In an effort to prevent such injury, cellular telephone shields have been developed, including a signal-absorbing mesh combined with shield mounting adhesive. These shields are secured over the speaker area of a cellular telephone, not because the internal signal transmission elements are necessarily behind the speaker area but because such placement positions the shield over the ear opening during use. Examples of these prior cellular telephone shields are NO DANGER™ Shield and the earlier version of the SAFE-T-SHIELD™ produced by the present applicant. While electronic tests, such as the Specific Absorption Rate Standard Test (SAR), the KEC Test and the GCL Test, have indicated that these prior shields substantially reduce the level of signal radiation entering the ear passageway, recent biological tests show that the prior shields reduce cell and tissue damage only very slightly, if at all.

It is thus an object of the present invention to provide a cellular and cordless telephone shield apparatus which reduces the intensity of signal radiation entering the ear to a level resulting in significant and definite reductions in tested cell and tissue damage.

It is another object of the present invention to provide such a shield apparatus which provides two mesh layers to increase the quantity of signal absorbing material between the telephone and the ear and also to increase the depth of the combined absorbing web so that a larger portion of signal radiation entering the shield at an oblique angle is intercepted.

It is still another object of the present invention to provide such a shield apparatus in which the strands of one mesh layer may overlap and cover openings between the strands of the other mesh layer to further intercept signal radiation.

It is finally an object of the present invention to provide such a shield apparatus which is reliable, durable and economical to manufacture.

### SUMMARY OF THE INVENTION

The present invention accomplishes the above-stated objectives, as well as others, as may be determined by a fair reading and interpretation of the entire specification.

A shielded telephone apparatus is provided, including a telephone which is one of a cellular telephone and a cordless telephone having a speaker opening; a first mesh layer for absorbing signal radiation while permitting passage of sound waves; first securing mechanism securing the first mesh layer over the speaker opening; a second mesh layer for absorbing residual signal radiation passing through the first mesh layer while permitting passage of sound waves; and second securing mechanism securing the second mesh layer over the first mesh layer.

A shield apparatus is further provided for placement over speaker openings of a cellular or cordless telephone to obstruct passage of harmful electromagnetic signal radiation from the telephone to the user ear, including a first glue ring for bonding the apparatus over the speaker openings of a telephone; a first mesh layer adhesively engaged by the first glue ring for absorbing signal radiation while permitting passage of sound waves; a second glue ring adhesively engaging the first mesh layer; and a second mesh layer engaged by the second glue ring for absorbing residual signal radiation penetrating the first mesh layer while permitting passage of sound waves.

The shield apparatus preferably additionally includes a flexible backing sheet covering which is removably engaged by the first glue ring, for preventing contact with the first glue ring until the apparatus is to be installed on a telephone. The shield apparatus preferably still additionally includes a metal frame ring bonded to the second mesh layer and extending along the periphery of the second mesh layer for absorbing radiation directed laterally toward the user ear. The frame ring has an exposed face and the apparatus preferably additionally includes a bead of solidified gelatin extending along the exposed face of the frame ring. The first mesh layer and the second mesh layer preferably are formed of a polycarbon metallic fiber. The first and second glue rings and the first and second mesh layers are preferably sized and dimensioned to have a matching elliptical perimeter shape.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a perspective view of the shield apparatus with the backing sheet partially pealed away for apparatus installation.

FIG. 2 is a perspective view of the apparatus installed on a cellular or cordless telephone.

FIG. 3 is an exploded view of the apparatus, showing the order and relationships of the various layers from which the apparatus is constructed.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

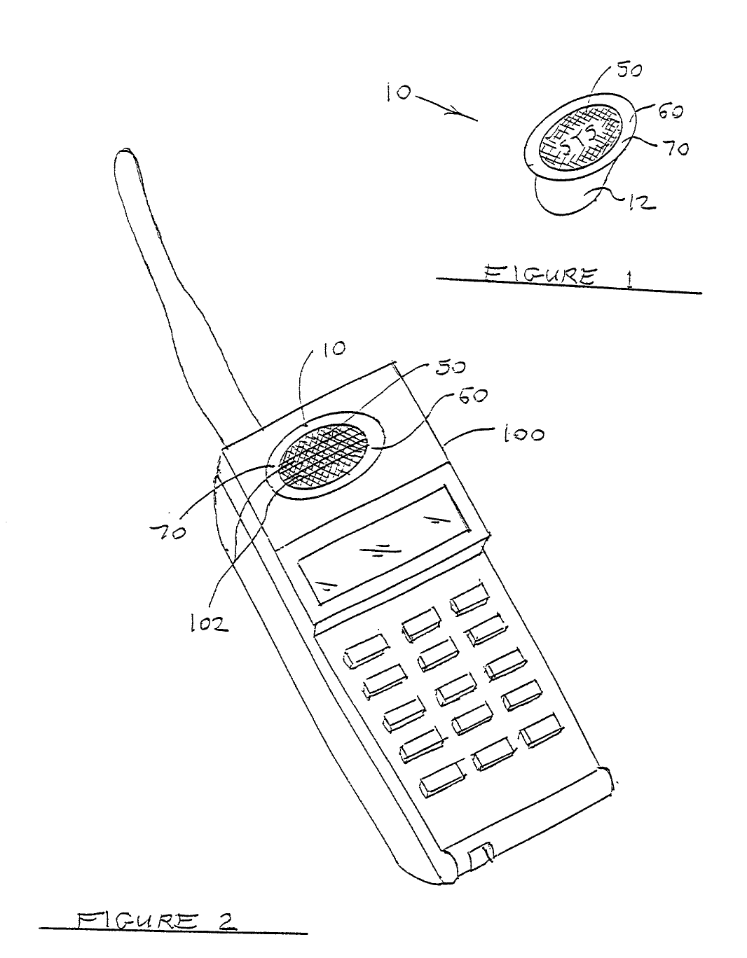

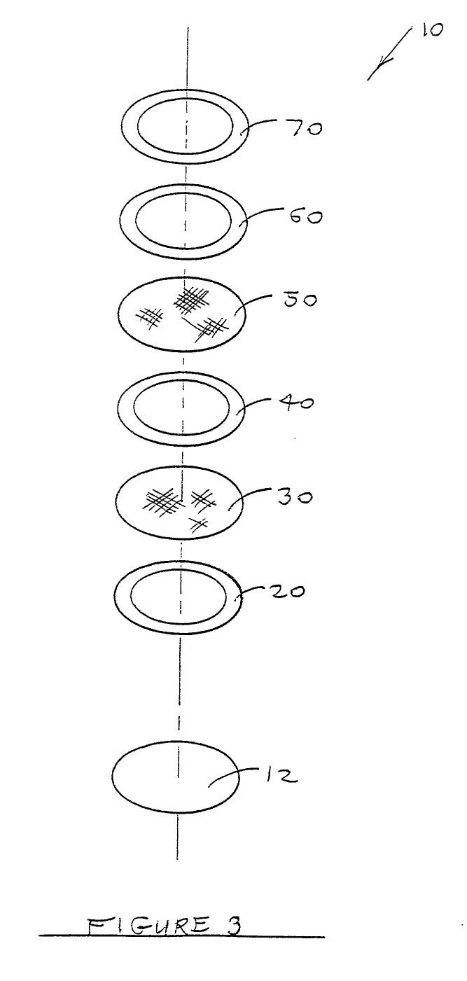

Referring to FIGS. 1-3, an improved shield apparatus 10 is provided for placement over the speaker of a cellular or cordless telephone 100 to obstruct passage of harmful electromagnetic signal radiation from the telephone 100 to the ear of the user. Apparatus 10 incorporates several layers of various materials which, in their order from telephone mounting surface outward, include a first glue ring 20 for bonding apparatus 10 over the speaker openings 102 of a telephone 100, a first mesh layer 30 adhesively engaged by the first glue ring 20 for absorbing signal radiation while permitting passage of sound waves, a second glue ring 40 adhesively engaging first mesh layer 30 and a second mesh layer 50 engaged by second glue ring 40 for absorbing residual signal radiation passing through first mesh layer 30. See FIG. 3. A backing sheet 12 preferably covers the exposed face of first glue ring 20 until apparatus 10 is to be installed on a telephone 100, whereupon backing sheet 12 is pealed away and discarded to expose first glue ring 20.

To absorb radiation directed toward the ear from the periphery of apparatus 10 and to enhance the appearance of apparatus 10, the apparatus preferably additionally includes a resilient metal frame ring 60 which is bonded with a suitable adhesive to the outward face of second mesh layer 50 so that the frame ring 60 extends along the entire second mesh layer 50 perimeter. Frame ring 60 also helps prevent the edges of second mesh layer 50 from becoming caught on and loosened by objects with which the telephone 100 comes into contact, and preferably is attractively colored to enhance the aesthetic quality of apparatus 10. A company name or other identifying information is preferably printed on the outward surface of frame ring 60, such as by silk screening. A bead of solidified gelatin 70 is preferably provided over the exposed face of the frame ring 60.

The first and second mesh layers 30 and 50, respectively, are preferably formed of what is known as DENGY MESH™, which is a fabric made from polycarbon metallic fiber manufactured by NISSHINBO™. Second mesh layer 50 is preferably dyed an attractive color and is marked at its center with manufacturer trademark initials or a logo 52, such as by silkscreening. First and second glue rings 20 and 40, respectively, preferably follow the periphery of first and second mesh layers 30 and 50 and have ample interior area to permit clear passage of telephone speaker sound. First and second glue rings 20 and 40 are preferably formed of a glue manufactured by 3M Corporations™ having the product number 9690MP, although fabrication from any suitable adhesive is contemplated. Apparatus 10 may have any of numerous peripheral shapes, but is preferably elliptical, with all of the layers having a correspondingly dimensioned elliptical shape.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. A shielded telephone apparatus, comprising:
a telephone which is one of a cellular telephone and a cordless telephone having a speaker opening;
a first mesh layer for absorbing signal radiation while permitting passage of sound waves;
first securing means securing said first mesh layer over said speaker opening;
a second mesh layer for absorbing residual signal radiation passing through said first mesh layer while permitting passage of sound waves;
and second securing means securing said second mesh layer over said first mesh layer.

2. A shield apparatus for placement over speaker openings of a cellular or cordless telephone to obstruct passage of harmful electromagnetic signal radiation from the telephone to the user ear, comprising:
a first glue ring for bonding the apparatus over the speaker openings of a telephone; a first mesh layer adhesively engaged by said first glue ring for absorbing signal radiation while permitting passage of sound waves;
a second glue ring adhesively engaging said first mesh layer;
and a second mesh layer engaged by said second glue ring for absorbing residual signal radiation penetrating said first mesh layer while permitting passage of sound waves.

3. The shield apparatus of claim 2, additionally comprising a flexible backing sheet covering removably engaged by said first glue ring, for preventing contact with said first glue ring until the apparatus is to be installed on a telephone.

4. The shield apparatus of claim 2, additionally comprising a metal frame ring bonded to said second mesh layer and extending along the periphery of said second mesh layer for absorbing radiation directed laterally toward the user ear.

5. The shield apparatus of claim 4, wherein said frame ring has an exposed face, additionally comprising a bead of solidified gelatin extending along the exposed face of said frame ring.

6. The shield apparatus of claim 2, wherein said first mesh layer and said second mesh layer are formed of a fabric made from polycarbon metallic fiber.

7. The shield apparatus of claim 2, wherein said first and second glue rings and said first and second mesh layers are sized and dimensioned to have a matching elliptical perimeter shape.
